(19) United States
(12) Patent Application Publication
(10) Pub. No.: US 2009/0229488 A1
(43) Pub. Date: Sep. 17, 2009

(54) Pivot Wheel Assembly and Powered Pallet with Pivot Wheel Assembly

(76) Inventor: Glen Ward, Grass Valley, CA (US)

Correspondence Address: COURTNEY STANIFORD & GREGORY LLP, P.O. BOX 9686, SAN JOSE, CA, 95157, US

(21) Appl. No.: 12/270,663

(22) Filed: Nov. 13, 2008

Related U.S. Application Data
(60) Provisional application No. 60/988,310, filed on Nov. 15, 2007.

(51) Int. Cl. B62D 59/04; B60B 19/00; B60K 17/34; B61J 1/10; B61D 15/00; B61C 3/00

(52) U.S. Cl. 104/288; 301/6.5; 180/234

(57) ABSTRACT

Embodiments of the pivot wheel assembly include a motor and a wheel. For example, a pallet may include a pivot wheel assembly at each corner, and each wheel is driven by its own motor. The pivot wheel assembly pivots and locks in the two 90 degree positions used for X and Y travel of the pallet. In some embodiments, each wheel assembly can be positioned in various positions in addition to the 90 degree positions. For example, the four wheel assemblies can be positioned to allow the entire pallet to rotate about its own center.

### RELATED APPLICATIONS

This application claims the benefit of U.S. Provisional Patent Application No. 60/988,310, filed Nov. 15, 2007, which is incorporated by reference herein in its entirety.

### TECHNICAL FIELD

The disclosure herein relates generally to a pallet apparatus for moving parts and materials in a manufacturing environment.

### BACKGROUND

Various powered pallet assemblies (“powered pallets”) have different mechanisms for changing direction of the pallet. Powered pallets may be designed for use on trackways or for use on floors. An example of a powered pallet for use on intersecting trackways is the PowerPallet™, available from Ward Systems, Inc. The PowerPallet™ is described in U.S. Pat. No. 5,857,413 and uses multiple cams and gears to effect the change in wheel direction.

### BRIEF DESCRIPTION OF THE DRAWINGS

In the course of the detailed description to follow, reference will be made to the attached drawings. These drawings show different aspects of the present invention and, where appropriate, reference numerals illustrating like structures, components, materials and/or elements in different figures are labeled similarly. It is understood that various combinations of the structures, components, materials and/or elements, other than those specifically shown, are contemplated and are within the scope of the present inventions.

FIG. 1 is a view of a powered pallet assembly, according to an embodiment;

FIG. 2 is an exploded view of a powered pallet end, according to an embodiment;

FIG. 3 is a top view of a wheel pivot assembly with locking mechanism, according to an embodiment;

FIG. 4 is a bottom view of a wheel pivot assembly with a wheel pivot lock, according to an embodiment;

FIG. 5 is a view of a wheel pivot mechanism, according to an embodiment;

FIG. 6 is an exploded view of a wheel pivot mechanism, according to an embodiment;

FIG. 7 is a view of a wheel pivot lock, according to an embodiment;

FIG. 8 is an exploded view of a wheel pivot lock, according to an embodiment;

FIG. 9 is a view of a manual control enclosure, according to an embodiment;

FIG. 10 is an exploded view of a manual control enclosure, according to an embodiment;

FIG. 11 is view of an alternative embodiment of a powered pallet assembly, according to an embodiment; and

FIG. 12 is a view of two pivot wheels of the assembly of FIG. 11, according to an embodiment.

### DESCRIPTION

Embodiments of a powered pallet assembly as shown in the drawings and described herein reduce the parts count of a pallet compared to prior pallet, while allowing versatile movement of the pallet, including rotation of the entire pallet itself.

In an embodiment a pallet has one wheel on each of four corners. Each corner wheel is driven by its own motor. The wheel assembly pivots and locks in the two 90 degree positions used for X and Y travel. In some embodiments, each wheel assembly can be positioned in various positions in addition to the 90 degree positions. For example, the four wheel assemblies can be positioned to allow the entire pallet to rotate about its own center.

Four pivoting corner wheel/motor assemblies allow direction change and provide drive force for movement.

The pivot wheel assembly is suitable for a motorized (“powered”) pallet that drives from location to location within a conveyor environment. For example, the pivot wheel assembly and system can supplement the existing PowerPallet™ with a new method of changing the wheel direction and a new method of providing a drive system. Other applications are also possible.

In an embodiment, to change the orientation of a drive wheels, the wheel/motor assembly is unlocked. The motor then drives the wheel. The pivot point for the wheel/motor assembly is off center from the drive wheel. This causes the wheel/motor mechanism to freely rotate about its pivot point while the drive wheel is driving. The lock is released and the pivot assembly locks into the new orientation. This orientation is typically 90 degrees to the original orientation but can be at any angular orientation that facilitates the next directional use of the drive system.

The wheel/motor assembly forms an integral mechanism that is a rotating assembly. To change the direction the rotating assembly is unlocked and the wheels being off center with the pivot point become the drive force to pivot the wheels. The drive motors for each wheel assembly are used to drive the pallet in a direction and also to change the wheel orientation.

The figures show various elements of versions of a powered pallet including the pivot wheel assembly and system.

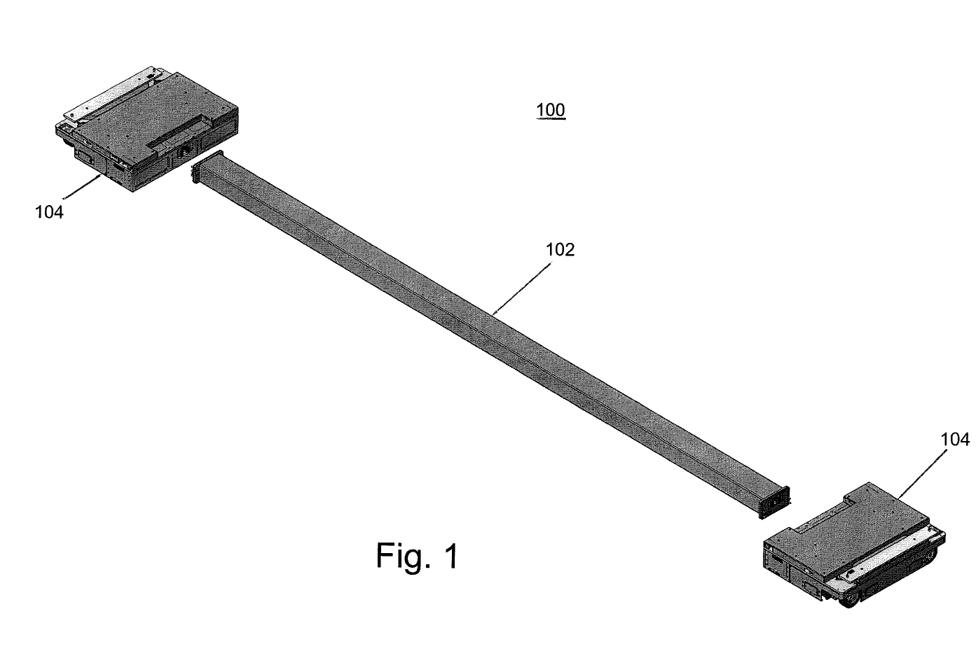

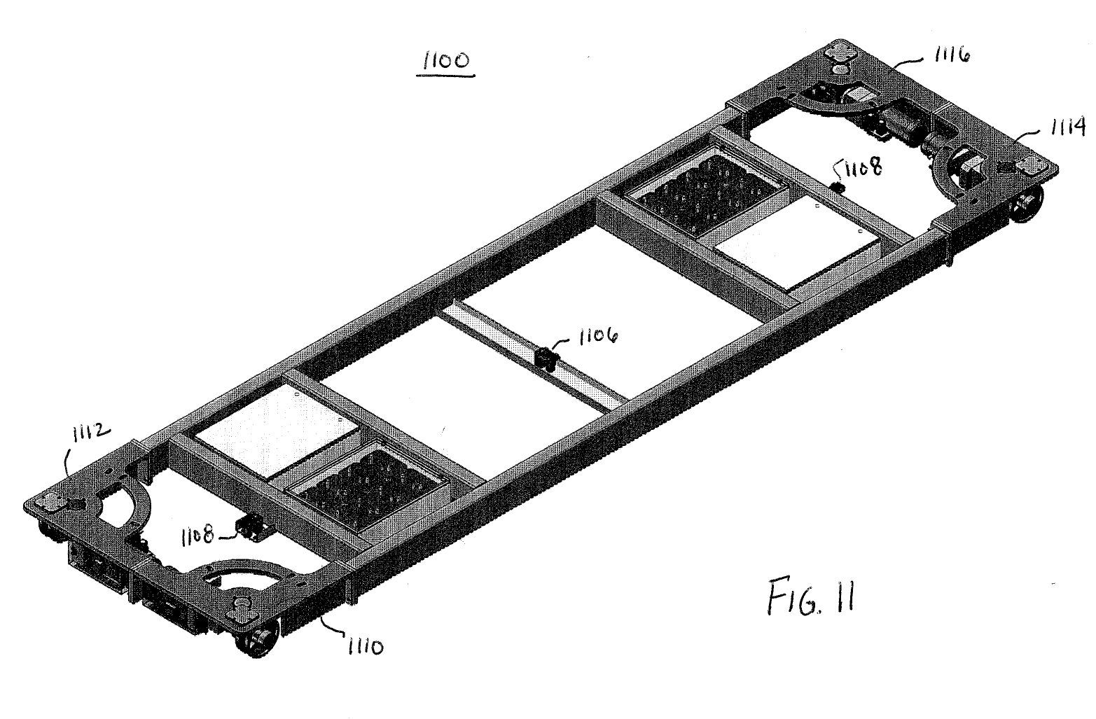

FIG. 1 is a view of a partially disassembled powered pallet 100 according to an embodiment. The pallet 100 includes a two pallet ends 104 and a cross beam 102 which make up the pallet structure. The pallet end 104 includes two pivot wheel assemblies as further illustrated and described below. Pallet ends 104 will also be referred to as wheel assemblies 104 herein. The pallet 100 is assembled by connecting each of the two pallet ends 104 to the cross beam 102. The pallet 100 is just one example of a pallet configuration that can use the novel pivot wheel assembly as described herein. The configuration of the pallet 100 is chosen based on the dimensions and weight of the load the pallet is expected to bear. In other embodiments, the pallet may consist of essentially two wheel assemblies 104 connected to each other directly or to a much shorter cross beam in proportion to the dimensions of the wheel assembly 104. In yet other embodiments (as shown with reference to FIG. 11 for example), the pallet may include a rectangular frame structure supported by four wheel assemblies.

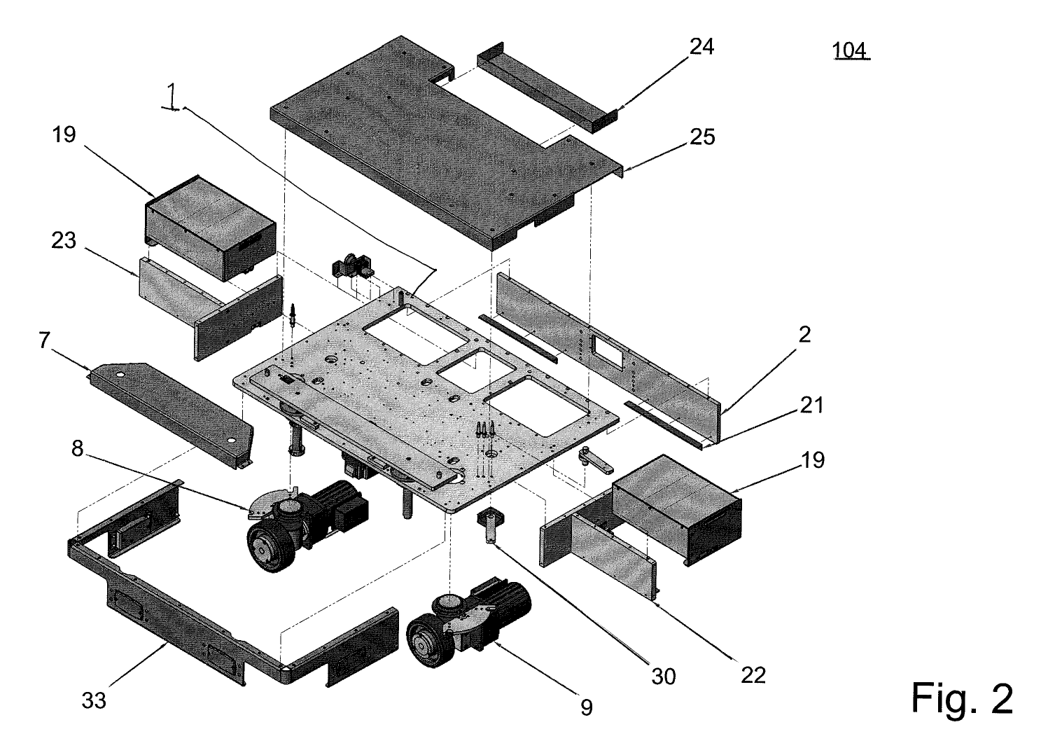

FIG. 2 is an exploded view of the wheel assembly 104. A top plate structure 1 is a main structural component of each wheel assembly 104 (also referred to as pallet ends 104 or ends 104) to which many of the other components attach. Attached to and below the top plate structure 1 are pivot wheel assemblies 8 and 9, vertical structural members 22 and 23, and a skirt 33. Attached to and above the top plate structure 1 are all of the electronic components, pivot lock actuators and covers 7, 24, and 25.

The powered pallet end 104 includes two pivot wheel assemblies, a left pivot wheel assembly 8 and a right pivot wheel assembly 9, and a pivot latch 30. Also shown are a mating plate 2, a gear enclosure 7, a battery tray 19, and a battery tray support 21. The power pallet end 104 further includes a left structure 22, a right structure 23, a controls enclosure 24 and 25, and a front skirt 33.

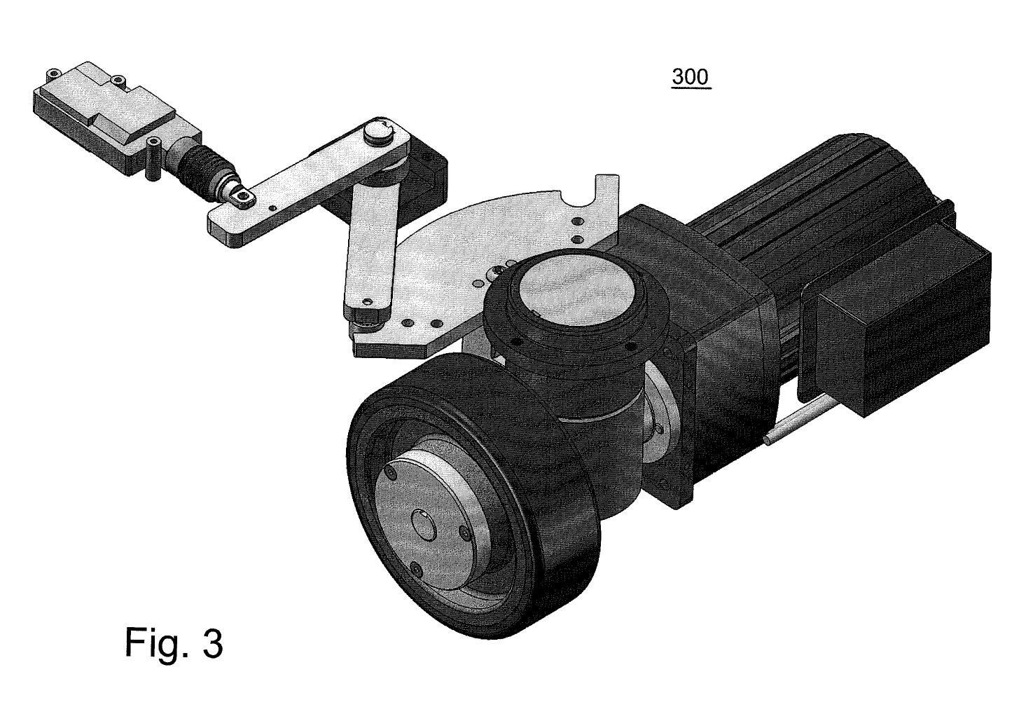

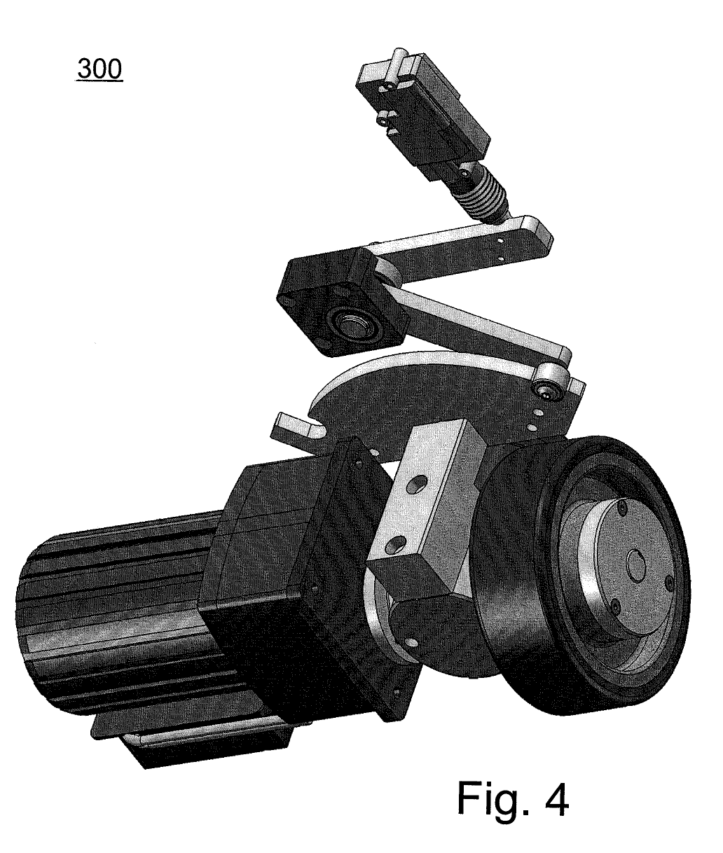

FIG. 3 is a view of a pivot wheel assembly 300 including a pivot wheel and wheel pivot lock showing the top portion of the assembly. FIG. 4 is a view of the pivot wheel assembly 300 showing the bottom portion of the assembly.

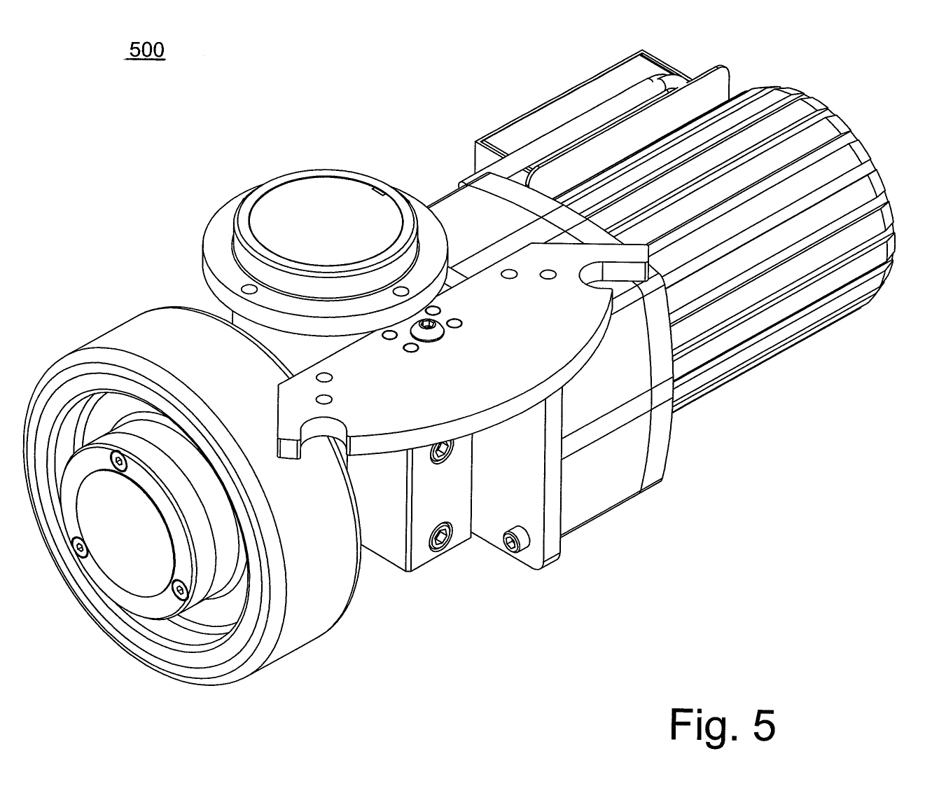

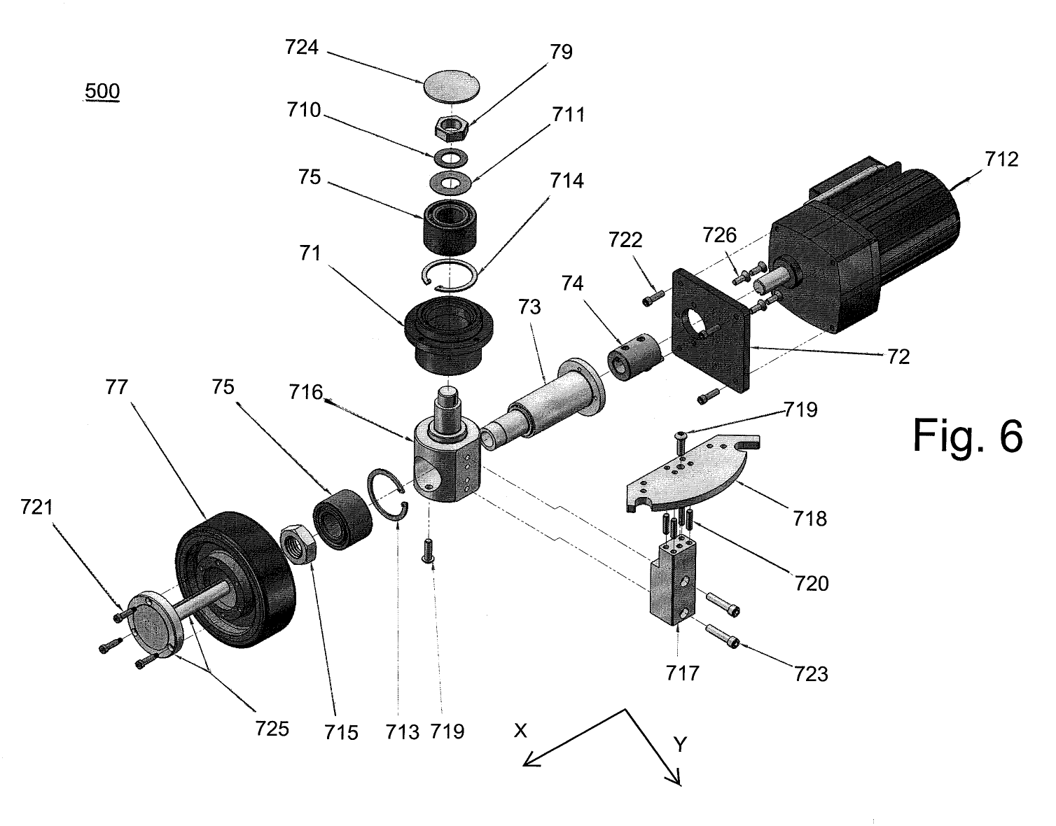

FIG. 5 is a view of a pivot wheel assembly 500 without a wheel pivot lock. FIG. 6 is an exploded view of the pivot wheel assembly 500. The pivot wheel assembly 500 is pivotable about an axis defined by the center of a pivot shaft 716. Shown disassembled from the pivot shaft 716 are a pivot cup 71, a retaining ring 714, a bearing 75, washers 710 and 711, a jam nut 79, and a pivot cap 724.

A wheel drive motor 712 is operable to drive a wheel 77 about its axis in one configuration, and also to rotate the assembly 500 about the pivot shaft 716 in another configuration. Screws 722 and 726 connect the motor 712 to a motor mount 72. A drive shaft coupling 74 and an axle 73 form part of a drive assembly connecting to the pivot shaft 716. A screw 719 retains the axel 73 in the pivot shaft 716. The drive assembly further includes a retaining ring 713, a bearing 75, a nut 715, the wheel 77, and a drive shaft insert 725 retained by screws 721.

A stop plate 718 includes detents as shown that allow the assembly to be fixed in a particular position such that the wheel 77 is oriented in a particular way with respect to the X-Y axis shown. For example, the wheel 77 is currently shown oriented so that it turns along the Y axis. The assembly 500 can also be oriented so that the wheel 77 turns along the X axis. As further described below, a pivot locking mechanism engages with the detents of the stop plate 718 to retain the assembly 50 in a particular position.

A stop plate mount 717 is connected to the stop plate 718 by dowels 720 and screw 719, and also to the pivot shaft 716 by screws 723.

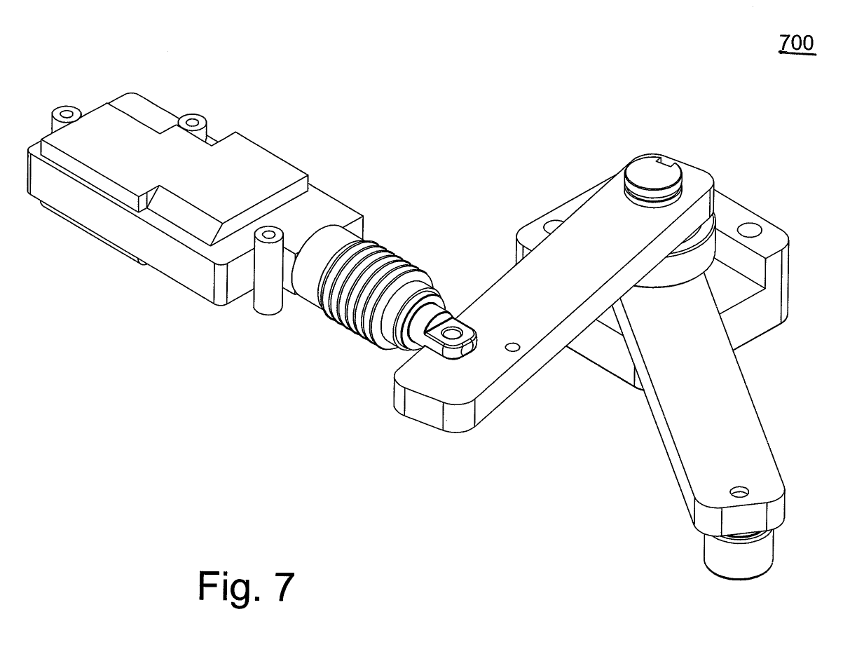

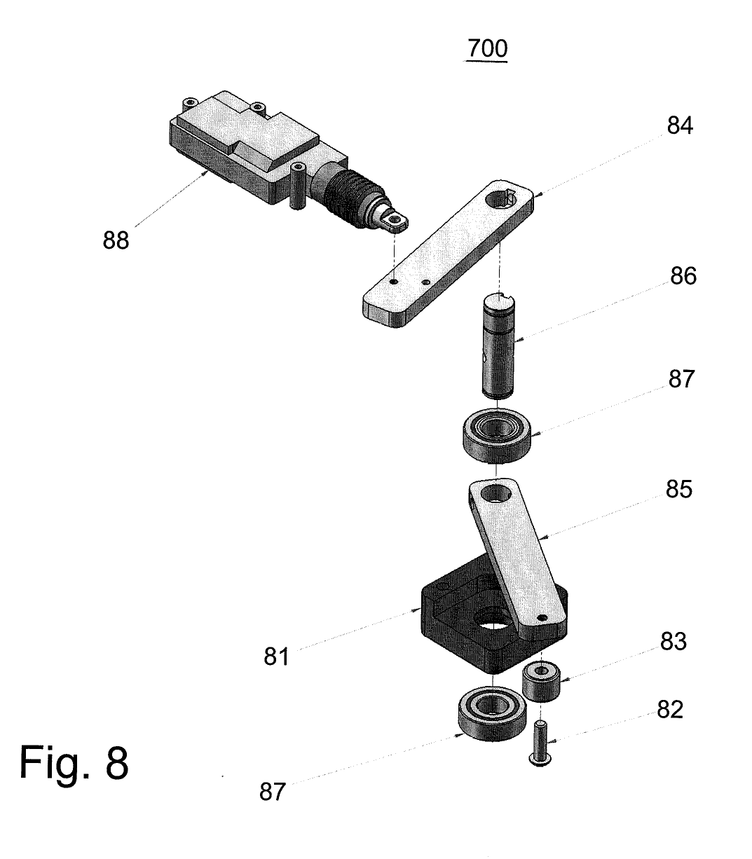

FIG. 7 is a wheel pivot lock 700 in an embodiment. FIG. 8 is an exploded view of the wheel pivot lock 700. Wheel pivot lock 700 includes a pivot shaft bearing housing 81, a cam follower lever 85, a lock release lever 84, and a lock release actuator 88. A cam follower 83 is connected the cam follower lever 85 with a screw 82. The cam follower 83 engages one of the detents in the stop plate 718 (as can be seen in assembly 300, FIGS. 3 and 4) to retain the wheel assembly 500 in a particular orientation.

The wheel pivot lock 700 further includes bearings 87 and lock release lever 86. The actuator 88 is electrically powered and moves lock release lever 84 so as to engage and disengage the cam follower 83 with respect to the detents in the stop plate 718. In operation, the lock release actuator 88 pulls the lock release lever 84 rotating shaft 86 swinging the lever 85 moving the cam follower 83 out of engagement with the lock plate 718.

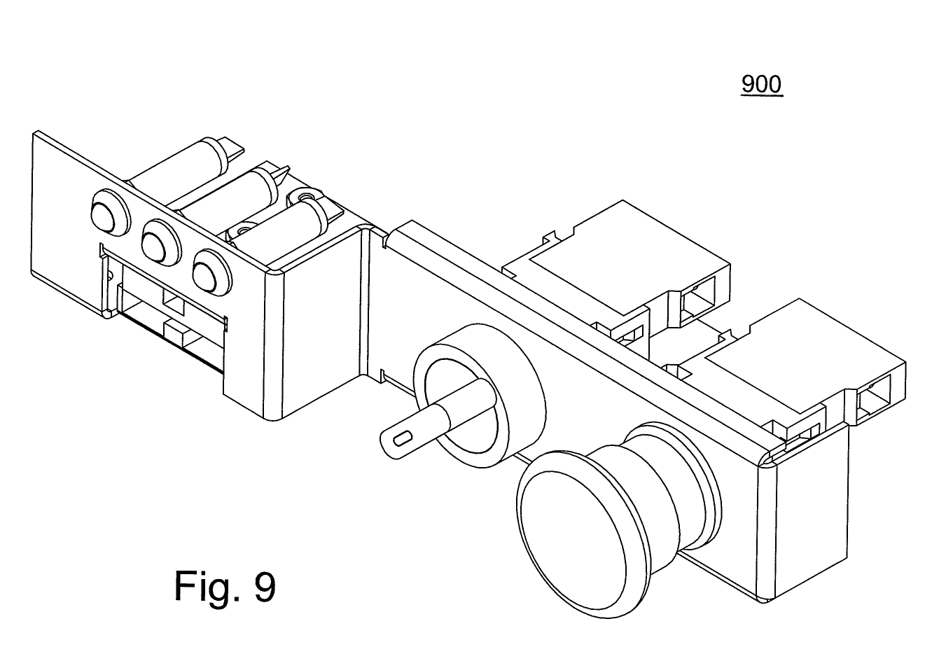

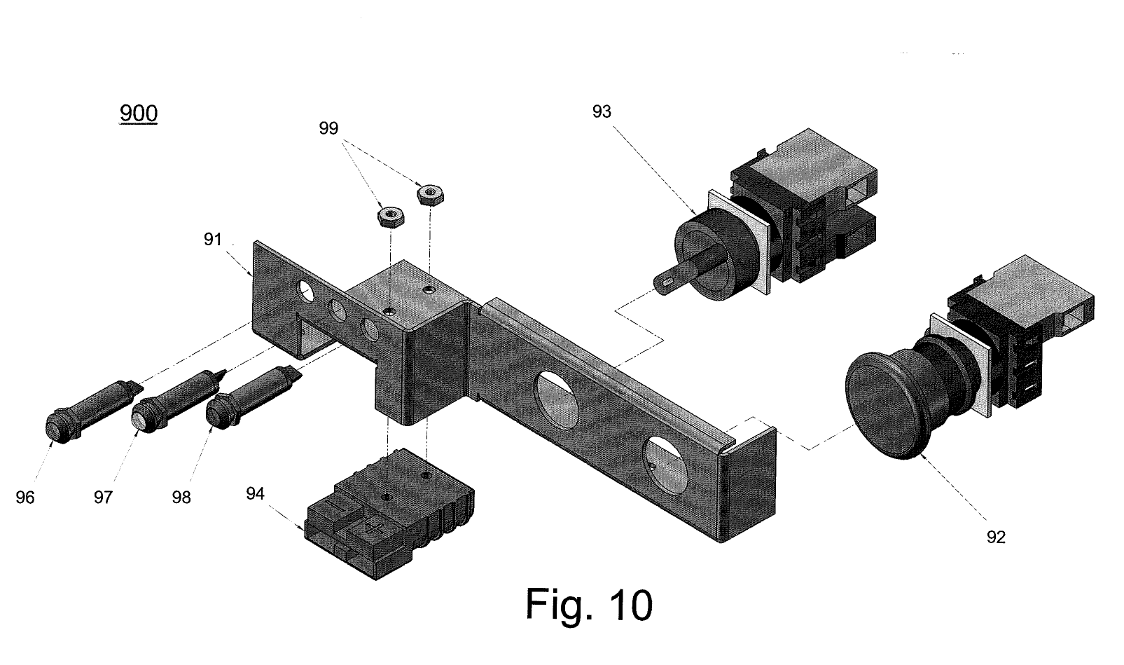

FIG. 9 is a view of a manual control enclosure and control panel 900 according to an embodiment. FIG. 10 is an exploded view of the enclosure 900 a frame 91 receives an On-Off switch 93 and an Emergency Off switch 92. A battery connector 94 is assembled to the frame 91 by nuts 99. Light emitting diodes (LEDs) 96, 97 and 98 signal various states of the powered pallet during operation. The control panel 900 is attached to the top plate structure 1 and is under the cover 25 (see FIG. 2)

FIG. 11 is a view of an alternative embodiment of a powered pallet 1100 with pivot wheel assemblies. The pallet 1100 includes four pivot wheel assemblies 1110, 1112, 1114, and 1116 supporting a rectangular pallet structure. The pallet 1100 is suitable for heavier loads than the pallet 100, but the principles of operation are similar between the two pallets.

1106 and 1108 are lock pin mechanisms. Lock pin mechanisms 1108 are used to lock the pallet to the floor or track structure. Lock pin mechanism 1106 is used to lock the pallet for rotation about its center point.

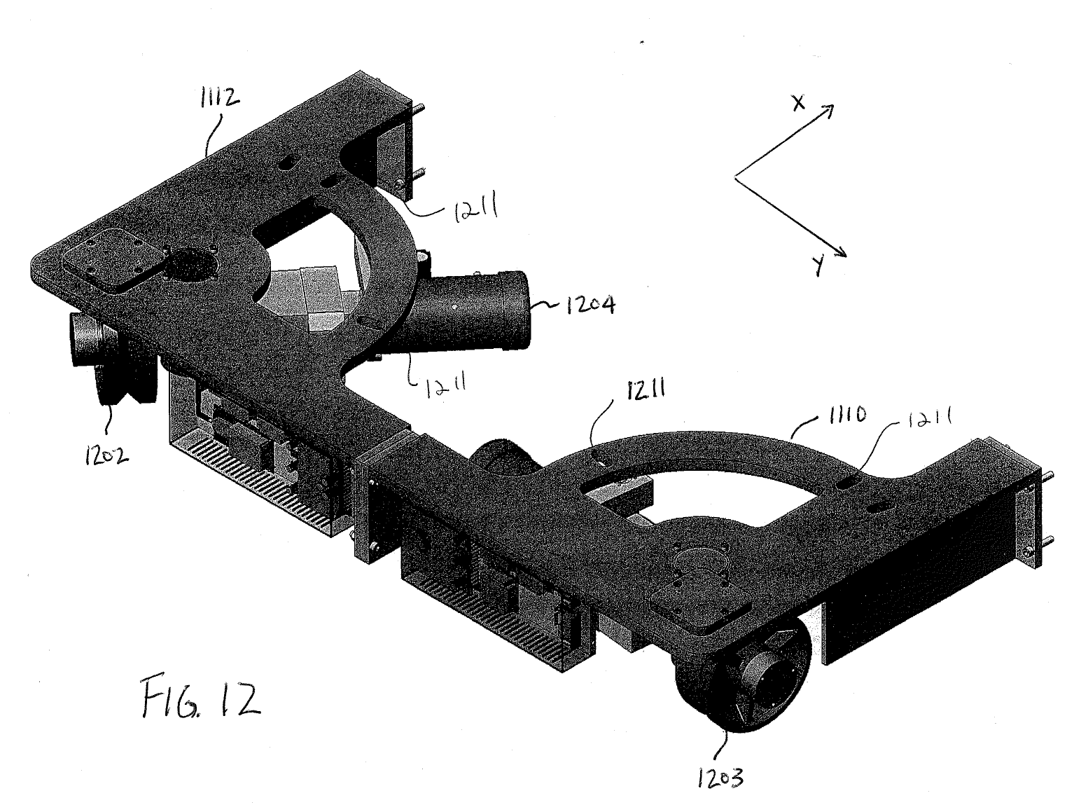

FIG. 12 is a view of two pivot wheel assemblies 1110 and 1112. A wheel pivot wheel and wheel pivot lock assembly 1204 is partially visible and includes a wheel 1202. The wheel 1202 is shown in a position between the X and Y axes. When all four wheels are rotated to this intermediate position, the pallet 1100 can be rotated in a circle. The wheel 1203 is shown in an orientation that allows the wheel to travel along the X axis. The wheels 1202 and 1203 are grooved so as to ride on a particular track. However, in different embodiments the wheels be designed to travel on a different type of track, or include rubber tires for traveling on a floor. In other embodiments, the pallet may be large enough to require more than pivot four wheel assemblies. For example, the pallet may include one pivot wheel assembly at each of four corners of a rectangular pallet and two or more additional pivot wheel assemblies located along the edges of the rectangular pallet structure. Holes 1211 are detents for locking mechanisms.

Embodiments as disclosed and claimed herein include a pivot wheel assembly, comprising: a motor coupled to drive a drive shaft; a wheel coupled to the drive shaft so as to be driven about a first axis of rotation defined by the drive shaft when the assembly is in a locked configuration; and a pivot shaft coupled to the drive shaft, wherein the pivot shaft defines a second axis of rotation that is orthogonal to the first axis of rotation, wherein the motor drives the assembly about the second axis of rotation when the assembly is in a unlocked configuration.

Embodiments further comprise a stop plate coupled to the pivot shaft.

Embodiments further comprise a wheel pivot lock configured to engage the stop plate for retaining the assembly in the locked configuration.

In an embodiment, the locked configuration comprises one of a plurality of positions for the wheel about the second axis of rotation.

In an embodiment, the stop plate comprises a plurality of detents, and wherein the wheel pivot lock comprises a cam follower that engages one of the plurality of detents when the assembly is in the locked configuration.

In an embodiment, the wheel pivot lock comprises an actuator coupled to a lock release lever and operable to move the lock release lever to configure the assembly in the unlocked configuration.

In an embodiment, the wheel pivot lock further comprises a pivot arm stop cam and a cam follower coupled to the lock release lever and configured to engage the stop plate.

Embodiments further include a powered pallet comprising: four wheels each coupled to a drive shaft, each drive shaft defining a first axis of rotation about the center of each wheel, wherein the four wheels are positioned with respect to each other to support four corners of a rectangular pallet structure; four pivot shafts each coupled to one of the drive shafts, wherein each pivot shaft defines a second axis of rotation orthogonal to a respective first axis of rotation; four motors, wherein each motor is coupleable to drive one of the drive shafts; and four wheel pivot locks, each configurable to place a motor and respective wheel in a locked or an unlocked configuration, wherein in the locked configuration a motor causes a respective drive shaft to rotate while a respective pivot shaft does not rotate, and wherein the unlocked position, the motor causes the respective drive shaft to rotate while the respective pivot shaft also rotates.

In an embodiment, the first axis of rotation for each of the four wheels is rotatable about the second axis of rotation in the unlocked configuration.

In an embodiment, the direction of travel of the pallet structure is changeable by rotating the first axis of rotation for each of the four wheels.

In an embodiment, the pallet structure is configurable to rotate in place by configuring the location of the first axis of rotation for each of the four wheels.

An embodiment further comprises four actuators for manipulating each of the four wheel pivot locks.

In an embodiment, the four actuators are electronic.

In an embodiment, the wheels travel on one or more tracks that are oriented at angles to one another, each defining a direction of travel.

Other embodiments include a powered pallet comprising: a plurality of pivot wheel assemblies, each pivot wheel assembly comprising, a motor coupled to drive a drive shaft; a wheel coupled to the drive shaft so as to be driven about a first axis of rotation defined by the drive shaft when the assembly is in a locked configuration; and a pivot shaft coupled to the drive shaft, wherein the pivot shaft defines a second axis of rotation that is orthogonal to the first axis of rotation, wherein the motor drives the assembly about the second axis of rotation when the assembly is in a unlocked configuration.

In an embodiment, each pivot wheel assembly further comprises a stop plate coupled to the pivot shaft.

In an embodiment, each pivot wheel assembly further comprises a wheel pivot lock configured to engage the stop plate for retaining the assembly in the locked configuration.

In an embodiment, the locked configuration comprises one of a plurality of positions for the wheel about the second axis of rotation.

In an embodiment, the stop plate comprises a plurality of detents, and wherein the wheel pivot lock comprises a cam follower that engages one of the plurality of detents when the assembly is in the locked configuration.

In an embodiment, the wheel pivot lock comprises an actuator coupled to a lock release lever and operable to move the lock release lever to configure the assembly in the unlocked configuration.

In an embodiment, the wheel pivot lock further comprises a pivot arm stop cam and a cam follower coupled to the lock release lever and configured to engage the stop plate.

What is claimed is:

1. A pivot wheel assembly, comprising:
a motor coupled to drive a drive shaft;
a wheel coupled to the drive shaft so as to be driven about a first axis of rotation defined by the drive shaft when the assembly is in a locked configuration; and
a pivot shaft coupled to the drive shaft, wherein the pivot shaft defines a second axis of rotation that is orthogonal to the first axis of rotation, wherein the motor drives the assembly about the second axis of rotation when the assembly is in a unlocked configuration.

2. The pivot wheel assembly of claim 1, further comprising a stop plate coupled to the pivot shaft.

3. The pivot wheel assembly of claim 2, further comprising a wheel pivot lock configured to engage the stop plate for retaining the assembly in the locked configuration.

4. The pivot wheel assembly of claim 1, wherein the locked configuration comprises one of a plurality of positions for the wheel about the second axis of rotation.

5. The pivot wheel assembly of claim 3, wherein the stop plate comprises a plurality of detents, and wherein the wheel pivot lock comprises a cam follower that engages one of the plurality of detents when the assembly is in the locked configuration.

6. The pivot wheel assembly of claim 3, wherein the wheel pivot lock comprises an actuator coupled to a lock release lever and operable to move the lock release lever to configure the assembly in the unlocked configuration.

7. The pivot wheel assembly of claim 6, wherein the wheel pivot lock further comprises a pivot arm stop cam and a cam follower coupled to the lock release lever and configured to engage the stop plate.

8. A powered pallet comprising:
four wheels each coupled to a drive shaft, each drive shaft defining a first axis of rotation about the center of each wheel, wherein the four wheels are positioned with respect to each other to support four corners of a rectangular pallet structure;
four pivot shafts each coupled to one of the drive shafts, wherein each pivot shaft defines a second axis of rotation orthogonal to a respective first axis of rotation;
four motors, wherein each motor is coupleable to drive one of the drive shafts; and
four wheel pivot locks, each configurable to place a motor and respective wheel in a locked or an unlocked configuration, wherein in the locked configuration a motor causes a respective drive shaft to rotate while a respective pivot shaft does not rotate, and wherein the unlocked position, the motor causes the respective drive shaft to rotate while the respective pivot shaft also rotates.

9. The powered pallet of claim 8, wherein the first axis of rotation for each of the four wheels is rotatable about the second axis of rotation in the unlocked configuration.

10. The powered pallet of claim 9, wherein the direction of travel of the pallet structure is changeable by rotating the first axis of rotation for each of the four wheels.

11. The powered pallet of claim 9, wherein the pallet structure is configurable to rotate in place by configuring the location of the first axis of rotation for each of the four wheels.

12. The powered pallet of claim 8, further comprising four actuators for manipulating each of the four wheel pivot locks.

13. The powered pallet of claim 8, wherein the four actuators are electronic.

14. The powered pallet of claim 10, wherein the wheels travel on one or more tracks that are oriented at angles to one another, each defining a direction of travel.

14. A powered pallet comprising:
a plurality of pivot wheel assemblies, each pivot wheel assembly comprising,
a motor coupled to drive a drive shaft;
a wheel coupled to the drive shaft so as to be driven about a first axis of rotation defined by the drive shaft when the assembly is in a locked configuration; and
a pivot shaft coupled to the drive shaft, wherein the pivot shaft defines a second axis of rotation that is orthogonal to the first axis of rotation, wherein the motor drives the assembly about the second axis of rotation when the assembly is in a unlocked configuration.

15. The powered pallet of claim 14, wherein each pivot wheel assembly further comprises a stop plate coupled to the pivot shaft.

16. The powered pallet of claim 15, wherein each pivot wheel assembly further comprises a wheel pivot lock configured to engage the stop plate for retaining the assembly in the locked configuration.

17. The powered pallet of claim 14, wherein the locked configuration comprises one of a plurality of positions for the wheel about the second axis of rotation.

18. The powered pallet of claim 16, wherein the stop plate comprises a plurality of detents, and wherein the wheel pivot lock comprises a cam follower that engages one of the plurality of detents when the assembly is in the locked configuration.

19. The powered pallet of claim 16, wherein the wheel pivot lock comprises an actuator coupled to a lock release lever and operable to move the lock release lever to configure the assembly in the unlocked configuration.

20. The powered pallet of claim 19, wherein the wheel pivot lock further comprises a pivot arm stop cam and a cam follower coupled to the lock release lever and configured to engage the stop plate.
